(19) United States
(12) Patent Application Publication
(10) Pub. No.: US 2017/0220312 A1
(43) Pub. Date: Aug. 3, 2017

(54) METHOD FOR PROVIDING COMMUNICATION SERVICE AMONG MOBILE TERMINALS BY USING NEARFIELD WIRELESS DEVICE

(71) Applicant: BENPLE INC., SEOUL (KR)

(72) Inventors: KYOUNG JUN LEE, SEOUL (KR); JUNG HO JUN, SEOUL (KR)

(73) Assignee: BENPLE INC., Seoul (KR)

(21) Appl. No.: 15/328,757

(22) PCT Filed: Jun. 19, 2015
(86) PCT No.: PCT/KR2015/006228

§ 371 Date: Jan. 24, 2017

(30) Foreign Application Priority Data
Jul. 24, 2014 (KR) 10-2014-0093720

(51) Int. Cl. G06F 3/14; H04W 8/24; H04L 12/18; H04B 5/00; H04W 4/02

(52) U.S. Cl. CPC G06F 3/1454; H04B 5/0056; H04W 4/021; H04L 12/1813; H04W 8/24; G06F 3/0484

(57) ABSTRACT

A method for providing a communication service includes receiving, by an operation server, a first tag ID of a first NFC tag through a first mobile terminal, receiving, by the operation server, a second tag ID of a second NFC tag through a second mobile terminal and checking whether the first and second mobile terminals are present in the same space using the first tag ID and the second tag ID, and forming, by the operation server, a communication space so that the first and second mobile terminals communicate messages with each other through the operation server in real time only when the first and second mobile terminals are present in the same space.

### CROSS-REFERENCE TO RELATED APPLICATION

This application, a national stage application under 35 USC 371(c) of PCT Application No. PCT/KR2015/006228, filed on Jun. 19, 2015, claims priority under 35 U.S.C. §119 to Korean Patent Application No. 10-2014-0093720, filed on Jul. 24, 2014, in the Korean Intellectual Property Office, the disclosure of which is incorporated by reference herein its entirety.

### TECHNICAL FIELD

Embodiments of the present inventive concepts relate to a method for providing a communication service between near mobile terminals, and more particularly to a method for providing a communication service capable of providing a communication space only between mobile terminals existing in the same space.

### DISCUSSION OF RELATED ART

In recent years, while various smart devices such as a smart phone or a tablet PC have become widely spread, users who use mobile applications installed in the smart device regardless of time and space rapidly increase. A text message service application among the applications enables to send or receive a text message to or from the other party through a mobile communication network.

Near field communication (NFC) refers to a contactless communication technology using a frequency band of 13.56 MHz, as one of electronic tag (or radio tag) technologies. As smart phones evolve, a smart phone with an NFC function is widely used. In particular, when the smart phone with an NFC function tags an NFC tag including an URL, the smart phone may access a web site corresponding to the URL using an application installed in the smart phone.

A beacon is a Bluetooth low energy (BLE) device capable of accessing a mobile application program installed in a smart phone when a customer carrying the smart phone enters a store. For example, the beacon may be embodied in a small Bluetooth transceiver in a USB memory shape. When the beacon is inserted into a USB port or a power outlet of a PC in the store, installation of the beacon ends.

A BLE-based beacon has a transmission distance widely ranging from 10 m to 50 m as compared to NFC and thus combines a location-based marketing platform and payment service. However, even if a plurality of users are present in the same space in which one or more NFC tags (or beacons) are installed, a community space for the same space is not automatically generated by an operation server, and a service allowing each of the plurality of users to send or receive messages through a community space generated by the operation server using his or her own mobile terminal is not provided.

### SUMMARY

A technical aspect of the present inventive concepts is to provide a method for providing a communication service which automatically generates a communication space between mobile terminals existing or present in the same space using at least one NFC tag installed in the same space, and in which users of the mobile terminals send or receive messages through the virtual communication space without going through an additory joining procedure or a additory authentication procedure.

Another technical aspect of the present inventive concepts is to provide a method for providing a communication service which automatically generates a communication space between mobile terminals existing or present in the same space using at least one beacon installed in the same space, and in which users of the mobile terminals send or receive messages through the communication space without going through an additory joining procedure or an additory authentication procedure.

Still another technical aspect of the present inventive concepts is to provide a method for providing a communication service which automatically generates a communication space by transmitting or receiving a beacon message by mobile terminals serving as a beacon existing or present in the same space, and in which users of the mobile terminals send or receive messages through the virtual communication space without going through an additory joining procedure or a additory authentication procedure.

An exemplary embodiment of the present inventive concepts is directed to a method for providing a communication service using a first mobile terminal communicating with a first NFC tag, a second mobile terminal communicating with a second NFC tag, and an operation server managing the first NFC tag and the second NFC tag, including receiving, by the operation server, a first tag ID of the first NFC tag through the first mobile terminal, receiving, by the operation server, a second tag ID of the second NFC tag through the second mobile terminal and checking whether the first mobile terminal and the second mobile terminal are present in the same space using the first tag ID and the second tag ID, and forming, by the operation server, a communication space so that the first mobile terminal and the second mobile terminal communicate messages with each other through the operation server in real time only when the first mobile terminal and the second mobile terminal are present in the same space.

The method further comprises displaying the messages through an interactive message window displayed on a display of each of the first mobile terminal and the second mobile terminal in real time by the operation server.

The interactive message window displayed on the first mobile terminal may be automatically activated when an application installed in the first mobile terminal receives the first tag ID, and the interactive message window displayed on the second mobile terminal may be automatically activated when an application installed in the second mobile terminal receives the second tag ID. The first NFC tag and the second NFC tag may be the same NFC tag installed in the same space.

Another exemplary embodiment of the present inventive concepts is directed to a method for providing a communication service using a first mobile terminal communicating with a first beacon, a second mobile terminal communicating with a second beacon, and an operation server managing the first beacon and the second beacon, including receiving, by the operation server, a first beacon ID of the first beacon through the first mobile terminal, receiving, by the operation server, a second beacon ID of the second beacon through the second mobile terminal and checking whether the first mobile terminal and the second mobile terminal are present in the same space using the first beacon ID and the second beacon ID, and forming, by the operation server, a communication space so that the first mobile terminal and the second mobile terminal can communicate messages with each other through the operation server in real time only when the first mobile terminal and the second mobile terminal are present in the same space.

The method further comprises displaying the messages through an interactive message window displayed on a display of each of the first mobile terminal and the second mobile terminal in real time by the operation server.

Still another exemplary embodiment of the present inventive concepts is directed to a method for providing a communication service, including executing, by a first mobile terminal serving as a beacon, an application installed in the first mobile terminal and requesting generation of a communication space to an operation server using the application, receiving, by the first mobile terminal, a uniform resource locator (URL) of the communication space from the operation server and generating a beacon message including the URL, and forming, by the operation server, the communication space only when a second mobile terminal receives the beacon message from the first mobile terminal so that the first mobile terminal and the second mobile terminal can communicate messages with each other through the operation server in real time.

The method further comprises displaying, by the operation server, the messages through an interactive message window displayed on a display of each of the first mobile terminal and the second mobile terminal in real time. The beacon message may further comprise digital contents.

Still another exemplary embodiment of the present inventive concepts is directed to a method for providing a communication service, including executing, a first mobile terminal serving as a beacon, an application installed in the first mobile terminal and requesting generation of a communication space to an operation server using the application, receiving, by the first mobile terminal, a uniform resource locator (URL) of the communication space from the operation server and generating a beacon message including a beacon identification (ID), receiving, a second mobile terminal, the beacon message from the first mobile terminal and transmitting the beacon ID to an ID search engine, and receiving the URL of the communication space corresponding to the beacon ID from the ID search engine, and forming, by the operation server, the communication space so that the first mobile terminal and the second mobile terminal communicate messages with each other through the operation server in real time.

The method further comprises displaying, by the operation server, the messages through an interactive message window displayed on a display of each of the first mobile terminal and the second mobile terminal.

Still another exemplary embodiment of the present inventive concepts is directed to a method for providing a communication service, including executing, by a first mobile terminal serving as a beacon, an application installed in the first mobile terminal and generating a communication space in the first mobile terminal using the application, generating, by the first mobile terminal, a beacon message including a beacon identification (ID), receiving, by a second mobile terminal, the beacon message from the first mobile terminal and searching for a communication space corresponding to the beacon ID, and forming, by the first mobile terminal, the communication space so that the first mobile terminal and the second mobile terminal can communicate messages with each other in real time.

The method further comprises displaying the messages through an interactive message window displayed on a display of each of the first mobile terminal and the second mobile terminal. The beacon ID may be the same as an ID of the first mobile terminal.

The method for providing a communication service may be recorded in a computer program and stored in a non-transitory computer readable recording medium.

According to one exemplary embodiment of the present inventive concepts, a method for providing a communication service may form a communication space between mobile terminals existing (or present) in the same space as a space in which an NFC tag or a beacon exists (or is present) without going through an additory joining procedure or an additory authentication procedure, and thus users of the mobile terminals may transmit or receive messages using the communication space.

According to another exemplary embodiment of the present inventive concepts, a method for providing a communication service may form a communication space between mobile terminals serving as beacons existing (or present) in the same space without going through an additory joining procedure or an additory authentication procedure, and thus users of the mobile terminals may transmit or receive messages using the communication space.

### BRIEF DESCRIPTION OF DRAWINGS

These and other features of the inventive concept will become more apparent by describing in detail exemplary embodiments thereof with reference to the accompanying drawings of which:

FIG. 1 shows a data flow of a system according to an exemplary embodiment of the present inventive concepts;

FIG. 2 is a flowchart for describing a method in which an operation server shown in FIG. 1 checks whether a plurality of mobile terminals exist (or are present) in the same space;

FIG. 3 shows a data flow of a system according to another exemplary embodiment of the present inventive concepts;

FIG. 4 is a flowchart for describing a group chatting method performed between the plurality of mobile terminals via the operation server according to an exemplary embodiment of the present inventive concepts;

FIG. 5 shows an exemplary embodiment of data input to an interactive message window for describing an operating method of a system according to an exemplary embodiment of the present inventive concepts;

FIG. 6 shows another exemplary embodiment of the data input to the interactive message window for describing the operating method of a system according to an exemplary embodiment of the present inventive concepts;

FIG. 7 shows a data flow of a system according to still another exemplary embodiment of the present inventive concepts;

FIG. 8 shows a data flow of a system according to still another exemplary embodiment of the present inventive concepts; and

FIG. 9 shows a data flow of a system according to still another exemplary embodiment of the present inventive concepts.

### DETAILED DESCRIPTION OF EXEMPLARY EMBODIMENTS

In the present specification, “transmitting or receiving signals (or data) using an application program installed in a mobile terminal” means “transmitting or receiving signals (or data) to or from a communication object (for example, NFC tag, beacon, or operation server) using a communication device (for example, a transmitter or a receiver) installed in the mobile terminal according to a control of the application program.

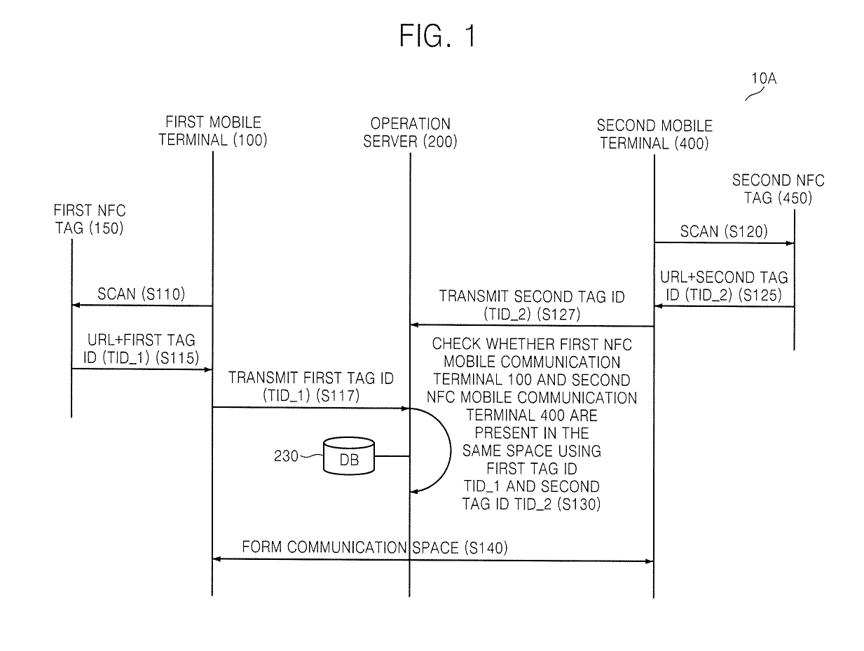

FIG. 1 shows a data flow of a system according to an exemplary embodiment of the present inventive concepts. Referring to FIG. 1, a system 10A may include a first near field communication (NFC) tag 150, a second NFC tag 450, a first mobile terminal 100, a second mobile terminal 400, and an operation server 200.

Each of the first mobile terminal 100 and the second mobile terminal 400 refers to a mobile terminal which includes an NFC reader capable of recognizing (or reading) information stored in each of the first NFC tag 150 and the second NFC tag 450. Here, the mobile terminal may include a laptop computer, a mobile phone, a smart phone, a tablet PC, an Internet of Things (IoT) device, an Internet of Everything (IoE) device, or a wearable computer.

According to an exemplary embodiment, the NFC reader may be embodied inside each of the first mobile terminal 100 and the second mobile terminal 400; however, the NFC reader may be embodied in a separate device, and may be attached to the outside of each of the first mobile terminal 100 and the second mobile terminal 400 to be used according to another exemplary embodiment.

Each of the first mobile terminal 100 and the second mobile terminal 400 may transmit or receive data to or from each other through interfacing, e.g., scan or contactless tagging, with each of the first NFC tag 150 and the second NFC tag 450 (S110 or S120).

In order to use a location-based communication service (or location-based communication space) provided by the operation server 200, when a user of the first mobile terminal 100 brings the first mobile terminal 100 closer to the first NFC tag 150, an NFC reader embodied in the first mobile terminal 100 may read information (for example, an uniform resource locator (URL) of the operation server 200 providing a location-based communication service and a first tag ID TID_1 of the first NFC tag 150) stored in the first NFC tag 150 (S115). A procedure of reading the information is referred to as scan or tagging.

In order to use a location-based communication service (or location-based communication space) provided by the operation server 200, when a user of the second mobile terminal 400 brings the second mobile terminal 400 closer to the second NFC tag 450, an NFC reader embodied in the second mobile terminal 400 may read information (for example, an URL of the operation server 200 providing a location-based communication service and a second tag ID TID_2 of the second NFC tag 450) stored in the second NFC tag 450 (S125). A procedure of reading the information is referred to as scan or tagging.

The URL may be an URL for accessing an administrator, e.g., the operation server 200, providing a location-based communication service, or may be an URL for accessing a website managed by the operation server 200.

For example, the website may be managed through the operation server 200 for each space in which the first NFC tag 150 and the second NFC tag 450 are installed. For example, when the first NFC tag 150 and the second NFC tag 450 are installed in a first store located in a first space, the website may be a website related to the first store. Moreover, when the first NFC tag 150 and the second NFC tag 450 are installed in a second store located in a second space different from the first space, the website may be a website related to the second store.

Each of the first tag ID TID_1 and a second tag ID TID_2 may be uniquely issued to each of the first NFC tag 150 and the second NFC tag 450 and managed by the operation server 200.

The first mobile terminal 100 may receive the URL of the operation server 200 transmitted from the first NFC tag 150 and the first tag ID TID_1 transmitted from the first NFC tag 150 (S115). The first mobile terminal 100 may access the operation server 200 using the URL of the operation server 200 transmitted from the first NFC tag 150, and transmit the received first tag ID TID_1 to the operation server 200 (S117).

The second mobile terminal 400 may receive the URL of the operation server 200 transmitted from the second NFC tag 450 and the second tag ID TID_2 transmitted from the second NFC tag 450 (S125). The second mobile terminal 400 may access the operation server 200 using the URL of the operation server 200 transmitted from the second NFC tag 450, and transmit the received second tag ID TID_2 to the operation server 200 (S127).

The operation server 200 may check whether the first mobile terminal 100 and the second mobile terminal 400 exist (or are present) in the same space using the first tag ID TID_1 transmitted from the first mobile terminal 100 and the second tag ID TID_2 transmitted from the second mobile terminal 400 (S130).

The operation server 200 stores information on where an NFC tag corresponding to the tag ID exists in a database by tag ID in advance, and thus the operation server 200 may check whether the first mobile terminal 100 and the second mobile terminal 400 exist in the same space (S130). Here, the same space refers to the same space or the same building in which both the first NFC tag 150 and the second NFC tag 450 are installed.

For convenience of description in FIG. 1, the first NFC tag 150 and the second NFC tag 450 are shown in separate NFC tags, but the first NFC tag 150 and the second NFC tag 450 may be the same NFC tag installed in the same space.

When the first mobile terminal 100 and the second mobile terminal 400 exist (or are present) in the same space, the operation server 200 forms a communication space so that the first mobile terminal 100 and the second mobile terminal 400 may send or receive messages through the operation server 200 in real time. That is, the operation server 200 may form a communication space for each space, and thus each of users existing (or present) in the same space may send or receive messages to or from other users using a communication space provided by the operation server 200 without going through an additory authentication procedure (for example, a procedure of inputting an ID and a password) using his or her own mobile terminal.

The operation server 200 may provide a mobile terminal of each of the users with the communication space through a mobile telephone network, a wireless internet, Wi-Fi, or a near communication network. In addition, regardless of whether or not registered as a member in the operation server 200, each of the users existing in the same space may transmit or receive messages to or from other users using the communication space provided by the operation server 200 using his or her own mobile terminal. However, users out of the same space may not transmit or receive messages to or from other users using the communication space.

According to an exemplary embodiment, each of users may transmit or receive messages to or from other users using a communication space only by scanning or tagging a corresponding NFC tag within time set by the operation server 200 through his or her own mobile terminal.

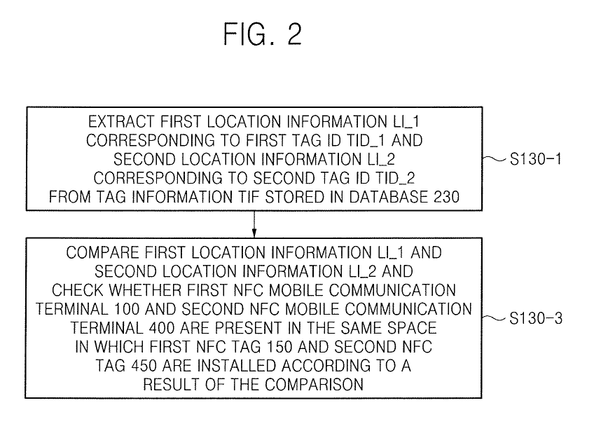

FIG. 2 is a flowchart which describes a method in which the operation server shown in FIG. 1 checks whether a plurality of mobile terminals exist in the same space. Referring to FIGS. 1 and 2, the operation server 200 may extract first location information LI_1 corresponding to the first tag ID TID_1 and second location information LI_2 corresponding to the second tag ID TID_2 from tag information TIF on a plurality of NFC tags stored in the database 230 (S130-1).

For example, the tag information TIF may include a list in which information matching each NFC tag managed by the operation server 200 (for example, contents information, space information, specific location information of the space, and/or the like) is grouped by the each NFC tag.

The operation server 200 may compare the first location information LI_1 with the second location information LI_2 each other, and check (or determine) whether the first mobile terminal 100, the second mobile terminal 400, the first NFC tag 150, and the second NFC tag 450 exist in the same space according to a result of the comparison (S130-3).

For example, each of the location information LI_1 and LI_2 may include space location information for identifying as a specific space (or specific building). Moreover, each of the location information LI_1 and LI_2 may further include specific location information for identifying a specific location in the specific space. For example, when the specific space is a coffee shop, the specific location information may be information on tables in the coffee shop.

Only when the first mobile terminal 100 and the second mobile terminal 400 exist in the same space, the operation server 200 may form a communication space in which the first mobile terminal 100 and the second mobile terminal 400 may transmit or receive messages to or from each other through the operation server 200 in real time (S140). For example, the operation server 200 may provide each of the first mobile terminal 100 and the second mobile terminal 400 with a website (or webpage) provided as a communication space by an administrator (or business operator) of a space (for example, store) in which the NFC tags 150 and 450 are installed.

Accordingly, an unspecified number of users, for example, a user of the first mobile terminal 100 and a user of the second mobile terminal 400, existing in the same space may send or receive messages through the communication space even without registering (or storing) a telephone number, a name, an address, an e-mail, and/or the like of the other party.

The messages may be displayed through an interactive message window executed by an application installed in each of the first mobile terminal 100 and the second mobile terminal 400 in real time. That is, a corresponding interactive message window is displayed through a display of each of the first mobile terminal 100 and the second mobile terminal 400. The corresponding interactive message window corresponds to a communication space.

The operation server 200 forms a communication space and transmits a formation result of the communication space to each of the mobile terminals 100 and 400 when the first tag ID TID_1 and the second tag ID TID_2 are received. According to an exemplary embodiment, an interactive message window displayed on the first mobile terminal 100 may be automatically activated when an application installed in the first mobile terminal 100 receives the first tag ID TID_1 or receives the formation result of the communication space from the operation server 200. Moreover, the interactive message window displayed on the second mobile terminal 400 may be automatically activated when an application installed in the second mobile terminal 400 receives the second tag ID TID_2 or receives the formation result of the communication space from the operation server 200.

Time at which the interactive message window on the first mobile terminal 100 is activated and time at which the interactive message window on the second mobile terminal 400 may be variously changed. As described above, a corresponding interactive message window may be automatically activated according to reception of a corresponding tag ID or the formation result of the communication space from the operation server 200 (for example, activation push message).

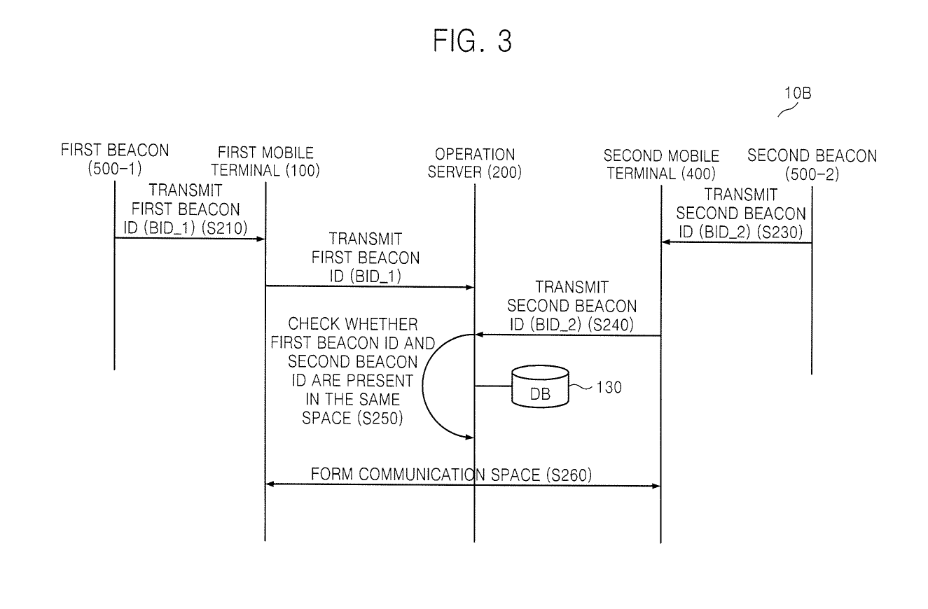

FIG. 3 shows a data flow of a system according to another exemplary embodiment of the present inventive concepts. Referring to FIG. 3, a system 10B includes a first mobile terminal 100, an operation server 200, a second mobile terminal 400, a first beacon 500-1, and a second beacon 500-2. Each of the first beacon 500-1 and the second beacon 500-2 may refer to a device for data communication using BLE. For example, a beacon can transmit data to a mobile terminal (for example, smart phone) if the mobile terminal only passes by a place in which the beacon is installed, without a need to bring the mobile terminal closer to an NFC tag and to tag the NFC tag as in NFC.

For example, each of the beacons 500-1 and 500-2 refers to hardware or a hardware module for communications using wireless personal area network (WPAN) or infrared data association (IrDA). For example, WPAN includes Bluetooth, Zigbee, ultra wide band (UWB), or the like.

A method for providing a communication service provided through the system 10A shown in FIG. 1 may be performed according to a clear intention of a user, for example, by tagging an NFC tag, but information output from the beacon 500-1 or 500-2 (for example, beacon ID (BID_1 or BID_2) is received by each of the mobile terminals 100 and 400 regardless of a clear intention of a user in the method for providing a communication service provided through the system 10B shown in FIG. 3, and thus a process in which a user of each of the mobile terminals 100 and 400 approves execution of the method for providing a communication service is required.

The first mobile terminal 100 may receive a first beacon ID BID_1 from the first beacon 500-1 (S210) and transmit the received first beacon ID BID_1 to the operation server 200 (S220). At this time, an application installed in the first mobile terminal 100 may ask a user of the first mobile terminal 100 whether to transmit the received first beacon ID BID_1 to the operation server 200, and transmit the received first beacon ID BID_1 to the operation server 200 when approved by the user (S220).

The second mobile terminal 400 may receive a second beacon ID BID_2 from the second beacon 500-2 (S230), and transmit the received second beacon ID BID_2 to the operation server 200 (S240). At this time, an application installed in the second mobile terminal 400 asks a user of the second mobile terminal 400 whether to transmit the received second beacon ID BID_2 to the operation server 200, and transmit the received second beacon ID BID_2 to the operation server 200 when approved by the user (S240).

The operation server 200 may check whether the first mobile terminal 100 and the second mobile terminal 400 exist (or are present) in the same space by using the first beacon ID BID_1 transmitted from the first mobile terminal 100 and the second beacon ID BID_2 transmitted from the second mobile terminal 400 (S250).

The operation server 200 may check whether the first beacon ID BID_1, the second beacon ID BID_2, the first mobile terminal 100, and the second mobile terminal 400 exist in the same space by using location information of the first beacon ID BID_1 and location information of the second beacon ID BID_2 stored in a database 130. For example, the same space may refer to the same space or the same building in which the first beacon 500-1 and the second beacon 500-2 are installed.

When it is checked that the first mobile terminal 100 and the second mobile terminal 400 exist in the same space, the operation server 200 may form a communication space so that the first mobile terminal 100 and the second mobile terminal 400 may communicate messages with each other through the operation server 200 in real time or on-the-fly (S260).

According to an exemplary embodiment, an interactive message window displayed on the first mobile terminal 100, when a user accesses the operation server 200 through the beacon ID BID_1 and wants chatting, may be generated when a communication space (for example, chat room) is generated by the operation server 200. According to an exemplary embodiment, the interactive message window displayed on the first mobile terminal 100 may be generated when a person invited to a chat room receives an invitation message and approves the invitation.

According to an exemplary embodiment, an interactive message window displayed on the second mobile terminal 400, when a user accesses the operation server 200 through the beacon ID BID_2 and wants chatting, may be generated when a communication space (for example, chat room) is generated by the operation server 200. According to an exemplary embodiment, the interactive message window displayed on the second mobile terminal 400 may be generated when a person invited to a chat room receives an invitation message and approves the invitation.

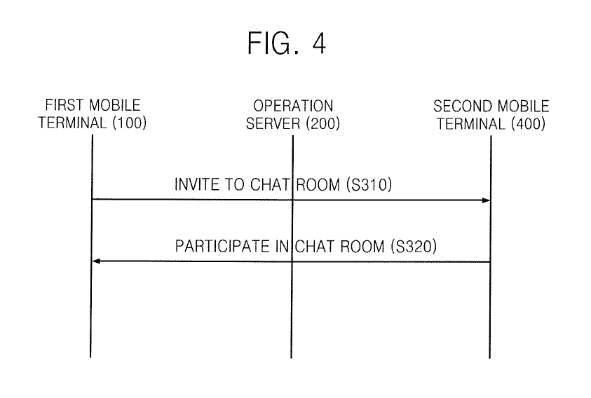

FIG. 4 is a flowchart for describing a group chatting method performed between a plurality of mobile terminals via the operation server shown in FIG. 1 or FIG. 3. Referring to FIGS. 1 to 4, when it is checked or determined that the first mobile terminal 100 and the second mobile terminal 400 exist in the same space, the first mobile terminal 100 may transmit an invitation to a chat room (for example, communication space) to the second mobile terminal 400 through the operation server 200 (S310). The second mobile terminal 400 may participate in the chat room through the operation server 200 based on the invitation (S320). That is, mobile terminals existing in the same space may use a communication service by participating in the chat room provided by the operation server 200. At this time, the number of mobile terminals which can be invited to the chat room is not limited.

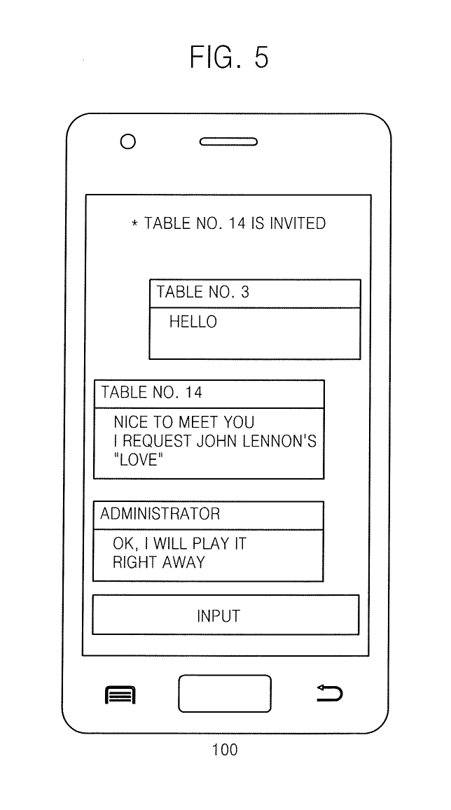

FIG. 5 shows an exemplary embodiment of data input through an interactive message window for describing an operation method of the system shown in FIG. 1 or FIG. 3. For convenience of description, it is assumed that a community space for a café is already formed in S140.

Referring to FIGS. 1 to 5, a first user of the first mobile terminal 100 sitting at a third table may invite a second user of the second mobile terminal 400 sitting at a fourteenth table to a community space provided by the operation server 200 through an interactive message window displayed on a display of the first mobile terminal 100. When the second user has a song to listen while drinking a coffee in the café and scan (or tag) the second NFC tag 450 installed at a table using the second mobile terminal 400, a window to input a title of the song to listen is displayed in an interactive message window displayed on a display of the second mobile terminal 400. The second user input the title to the window. An administrator of the community space plays the song in response to an input by the second user.

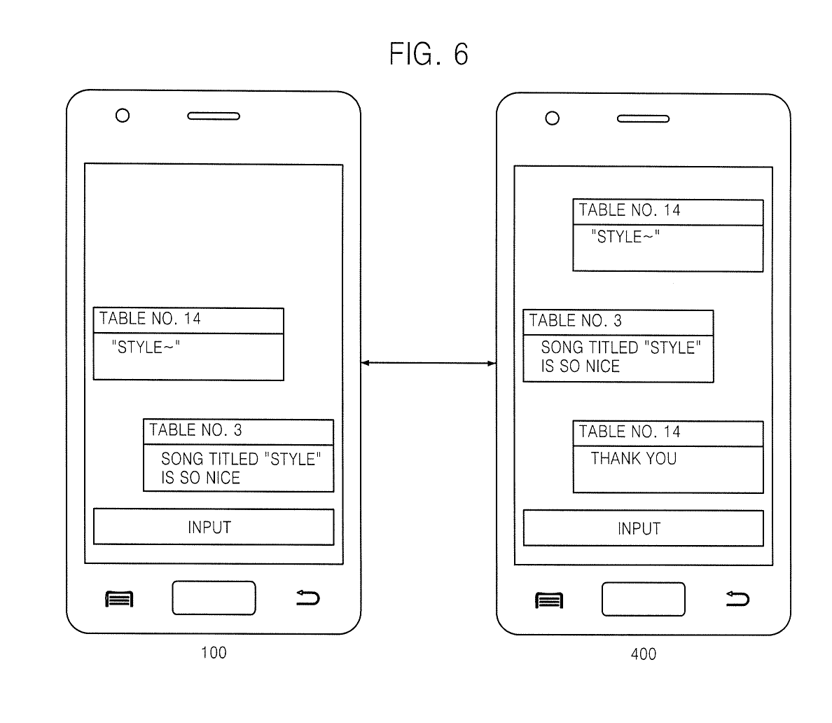

FIG. 6 shows another, exemplary embodiment of data input to an interactive message window for describing an operation method of the system shown in FIG. 1 or FIG. 3. For convenience of description, it is assumed that a community space for a café is already formed in S140.

Referring to FIGS. 1 to 6, the first user of the first mobile terminal 100 sitting at the third table may invite the second user of the second mobile terminal 400 sitting at the fourteenth table to the community space provided by the operation server 200 through the interactive message window displayed on the display of the first mobile terminal 100.

When the second user inputs a song request of “style˜” through the interactive message window executed by an application installed in the second mobile terminal 400, the message of “style˜” is displayed in the interactive message window executed by an application installed in the first mobile terminal 100. When the first user inputs a message of “song titled “style” is very good” through the interactive message window executed by the application installed in the first mobile terminal 100, the message of “song titled “style” is very good” is displayed in the interactive message window executed by the application installed in the second mobile terminal 400.

As shown in FIGS. 5 and 6, messages transmitted or received by the first user and the second user through the community space of the operation server 200 may be displayed in the interactive message window of each of the mobile terminals 100 and 400 in real time. According to another exemplary embodiment, the second mobile terminal 400 may be a terminal of an administrator managing the same space as a space in which the first mobile terminal 100 exists (or is present).

When a message is updated from the first mobile terminal 100 through the communication space formed between the first mobile terminal 100 and the second mobile terminal 400, the operation server 200 may transmit a update alarm request to the second mobile terminal 400. Accordingly, the second user of the second mobile terminal 400 may check the updated message according to the update alarm request and provide the first mobile terminal 100 with a service corresponding to the updated message through the operation server 200.

For example, the first user of the first mobile terminal 100 may request a music, customer's voices (or complaints), or service through a communication space formed for each space, and when the second user of the second mobile terminal 400 is an administrator managing a space, the second user may provide the first user with a necessary service in response to the request. According to an exemplary embodiment, an application capable of executing the method for providing a communication service shown in FIG. 1 or FIG. 3 may be installed in each of the mobile terminals 100 and 400.

The application may be downloaded from the operation server 200 to be installed. Moreover, the application may be downloaded from a web store or an application market to be installed.

The application installed in each of the first mobile terminal 100 and the second mobile terminal 400 may be automatically executed by tagging each of the first NFC tag 150 and the second NFC tag 450. At this time, the application executed in each of the mobile terminals 100 and 400 may activate an interactive message window for transmitting and receiving a plurality of messages through the communication space generated by the operation server 200.

The method described referring to FIGS. 5 and 6 may be applied to the communication space generated by the system 10B shown in FIG. 3 as it is. For example, when a communication space corresponds to a store, users may participate in a music request, a request for customer's voices, or a customer participation event using the communication space, and an administrator of the store may communicate with a customer.

When a communication space corresponds to a public place, users may transmit a damage report on facilities installed in the public place or suggestions in a message. When a communication space corresponds to a building, users may transmit a charging message of toilet paper or equipment.

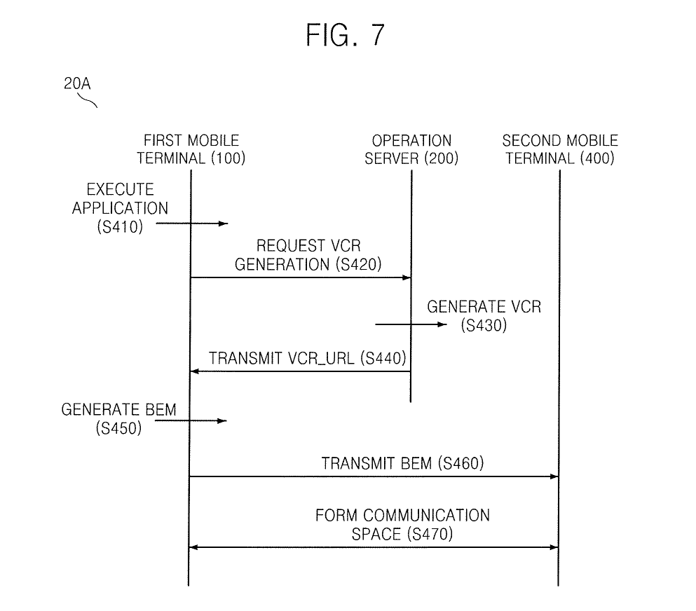

A method for providing a communication service described referring to FIGS. 7 to 9 is a method which enables communications between users in a specific space through transmission and reception of a beacon message BEM between mobile terminals based on a fact that a user's mobile terminal serves as a beacon.

Types of communication services described in FIGS. 7 to 9 may be classified according to a type of a beacon message as follows to be transmitted to a mobile terminal.

(1) When a beacon message carries an address (VCR_URL) of a communication space (VCR);
(2) When a beacon message carries a beacon ID (BID);
(3) When a beacon message carries an ID (DID) of a mobile terminal.

In addition, types of communication services described in FIGS. 7 to 9 may be classified according to a location in which a communication space VCR is generated.

(1) When the communication space VCR is generated in the operation server 200;
(2) When the communication space VCR is generated in the mobile terminal 100 and/or 400.

FIG. 7 shows a data flow of a system according to still another exemplary embodiment of the present inventive concepts. Referring to FIG. 7, a system 20A may include a first mobile terminal 100, a second mobile terminal 400, and an operation server 200.

The first mobile terminal 100, as a mobile terminal serving as a beacon, may generate a beacon message BEM using an application installed in the first mobile terminal 100, and broadcast the beacon message BEM to the second mobile terminal 400. When the first mobile terminal 100 and the second mobile terminal 400 are located in a specific space, the second mobile terminal 400 catches the beacon message BEM broadcast from the first mobile terminal 100, thereby enabling communication between the user of the first mobile terminal 100 and the user of the second mobile terminal 400.

For convenience of description in the present specification, a case in which the second mobile terminal 400 only receives the beacon message BEM is described, but the second mobile terminal 400 may be a plurality of mobile terminals according to an exemplary embodiment. Accordingly, communications between users of the plurality of mobile terminals may be enabled according to an exemplary embodiment.

The specific space may refer to a space in which the second mobile terminal 400 may receive the beacon message BEM from the first mobile terminal 100. That is, communications between the first mobile terminal 100 and the second mobile terminal 400 may be enabled within a range in which the beacon message BEM may be transmitted or received.

According to an exemplary embodiment, the second mobile terminal 400 serves as a beacon and broadcast the beacon message BEM to the first mobile terminal 100. When the first mobile terminal 100 and the second mobile terminal 400 are located in a specific space, the first mobile terminal 100 catches the beacon message BEM, thereby enabling communications between the user of the first mobile terminal 100 and the user of the second mobile terminal 400.

The first mobile terminal 100 capable of serving as a beacon executes the application installed in the first mobile terminal 100 (S410), and may request the operation server 200 to generate a virtual communication space (or virtual communication room) VCR using the application (S420).

The application installed in the first mobile terminal 100 may ask the user of the first mobile terminal 100 whether to request the operation server 200 to generate a virtual communication space VCR, and may request the operation server 200 to generate a virtual communication space VCR when approved by the user (S420).

The operation server 200 may generate a virtual communication space VCR which enables communications between the mobile terminals in response to a request to generate a virtual communication space VCR of the first mobile terminal 100 (S430), and transmit a URL (VCR_URL) of the virtual communication space VCR to the first mobile terminal 100 (S440).

The URL may be an URL for accessing an administrator providing a location-based communication service, for example, the operation server 200, or may be an URL for accessing a website managed by the operation server 200. For example, the website may be managed through the operation server 200.

The first mobile terminal 100 may receive an URL (VCR_URL) of the virtual communication space VCR from the operation server 200 (S440) and generate a beacon message BEM including the URL (VCR_URL) of the virtual communication space VCR using the application installed in the first mobile terminal 100 (S450).

The first mobile terminal 100 may access the virtual communication space VCR using the URL (VCR_URL) of the virtual communication space VCR received from the operation server 200.

According to an exemplary embodiment, the beacon message BEM may further include digital contents. The digital contents may refer to a product that can be manufactured, distributed, and consumed in a digitized manner. For example, the digital contents D_CONTS may refer to text files, image files, video files, mpeg-1 audio layer-3 (MP3) music files, or multimedia books.

For example, the user of the first mobile terminal 100 may generate a beacon message BEM including the URL (VCR_URL) of the virtual communication space VCR, a text including a phrase to invite the user of the second mobile terminal 400 to the virtual communication space VCR, an image, and the like by using the application installed in the first mobile terminal 100.

The second mobile terminal 400 may receive the beacon message BEM from the first mobile terminal 100 (S460), and may access the virtual communication space VCR by using the URL (VCR_URL) of the virtual communication space VCR included in the beacon message BEM.

When both the first mobile terminal 100 and the second mobile terminal 400 access the virtual communication space VCR generated in the operation server 200, the operation server 200 may form a virtual communication space VCR so that the first mobile terminal 100 and the second mobile terminal 400 communicate messages with each other through the operation server 200 in real time (S470).

The messages may be displayed through an interactive message window executed by the application installed in each of the first mobile terminal 100 and the second mobile terminal 400. That is, a corresponding interactive message window is displayed through a display of each of the first mobile terminal 100 and the second mobile terminal 400. The corresponding interactive message window corresponds to the virtual communication space VCR.

A method of providing description with reference to FIGS. 5 and 6 may be applied to a virtual communication space generated by the system 20A shown in FIG. 7 as it is. That is, the operation server 200 may form a virtual communication space VCR for each space, and thus each of users existing (or present) in a specific space may send or receive a plurality of messages with other users in the virtual communication space VCR provided by the operation server 200 without going through an additory authentication procedure (for example, a procedure to input an ID and a password) using his or her own mobile terminal.

The operation server 200 may provide a mobile terminal of each of the user with the virtual communication space VCR through a mobile telephone network, the wireless Internet, Wi-Fi, or a near communication network. In addition, regardless of whether or not subscribing to the operation server 200 as a member, each of users existing in a specific space may transmit or receive messages with other users in the virtual communication space VCR provided by the operation server 200 using his or her mobile terminal. However, users out of the specific space cannot transmit or receive messages to or from other users using the virtual communication space.

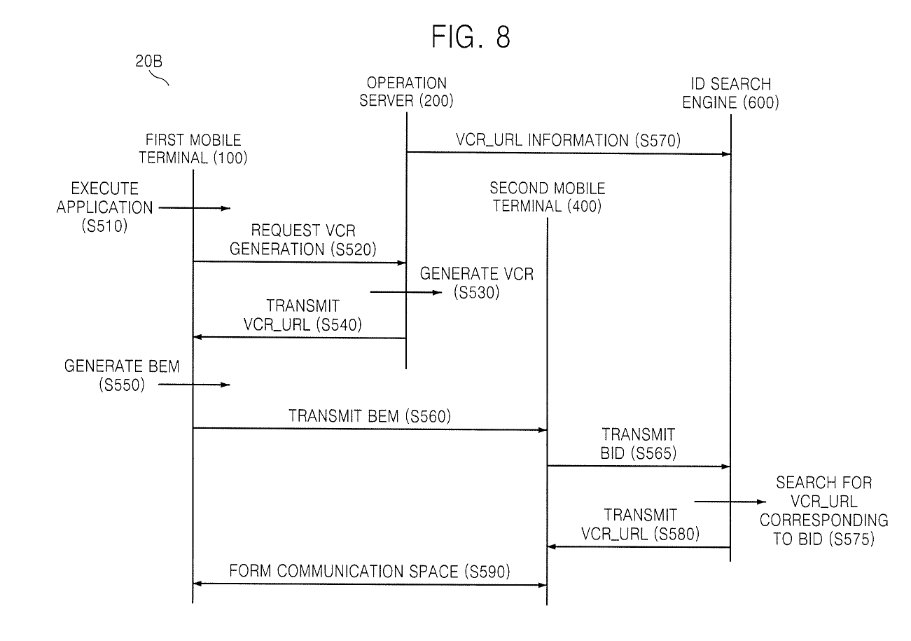

FIG. 8 shows a data flow of a system according to still another exemplary embodiment of the present inventive concepts. Referring to FIG. 8, a system 20B may include a first mobile terminal 100, a second mobile terminal 400, an operation server 200, and an ID search engine 600.

The first mobile terminal 100 capable of serving as a beacon may execute an application installed in the first mobile terminal 100 (S510), and request the operation server 200 to generate a virtual communication room VCR using the application (S520). The application installed in the first mobile terminal 100 asks a user of the first mobile terminal 100 whether to request the operation server 200 to generate a virtual communication space VCR, and may request the operation server 200 to generate the virtual communication space VCR when approved by the user (S520).

The operation server 200 may generate a virtual communication space VCR which enables communications between mobile terminals in response to a request to generate the virtual communication space VCR by the first mobile terminal 100 (S530), and transmit an URL (VCR_URL) of the virtual communication space VCR to the first mobile terminal 100 (S540).

The URL may be an URL for accessing an administrator providing a location-based communication service, e.g., the operation server 200, or an URL for accessing a website managed by the operation server 200. For example, the website may be managed through the operation server 200.

The first mobile terminal 100 may receive the URL (VCR_URL) of the virtual communication space VCR from the operation server 200 (S540), and generate a beacon message BEM including a beacon ID (BID) using the application installed in the first mobile terminal 100 (S550).

The first mobile terminal 100 may access the virtual communication space VCR using the URL (VCR_URL) of the virtual communication space VCR received from the operation server 200. According to an exemplary embodiment, the beacon ID (BID) may be the same as an ID (DID) of a mobile terminal.

According to an exemplary embodiment, the beacon message BEM may further include digital contents. The digital contents may refer to a product which can be manufactured, distributed, or consumed in a digitized manner. For example, the digitized contents D_CONTS may refer to text files, image files, video files, MP3 music files, multimedia books, or the like.

For example, the user of the first mobile terminal 100 may generate a beacon message BEM including a beacon ID (BID), a text composed of a phrase to invite a user of the second mobile terminal 400 to a virtual communication space VCR, an image, and the like using the application installed in the first mobile terminal 100.

The second mobile terminal 400 may receive the beacon message BEM including a beacon ID (BID) from the first mobile terminal 100 (S560). The second mobile terminal 400 may transmit the beacon ID (BID) transmitted from the first mobile terminal 100 to the ID search engine 600 (S565), and request an inquiry, e.g., search, for the beacon ID (BID).

The ID search engine 600 searches for an URL (VCR_URL) of a virtual communication space VCR corresponding to the received beacon ID (BID) (S575), and transmit the searched URL (VCR_URL) of the virtual communication space (VCR) to the second mobile terminal 400 (S580).

According to an exemplary embodiment, the ID search engine 600 may communicate with the operation server 200 to search for an URL (VCR_URL) of a virtual communication space (VCR) which is generated or disappears in real time. For example, the operation server 200 may transmit information on an URL (VCR_URL) of a virtual communication space VCR generated according to the request to generate a virtual communication space VCR by the first mobile terminal 100 to the ID search engine 600. The second mobile terminal 400 may access the virtual communication space VCR using the URL (VCR_URL) of the virtual communication space VCR received from the ID search engine 600.

When both the first mobile terminal 100 and the second mobile terminal 400 access a virtual communication space VCR generated within the operation server 200, the operation server 200 may form the virtual communication space VCR so that the first mobile terminal 100 and the second mobile terminal 400 communicate a plurality of messages with each other through the operation server 200 in real time (S590).

The messages may be displayed in real time through an interactive message window which is executed by an application installed in each of the first mobile terminal 100 and the second mobile terminal 400. That is, a corresponding interactive message window is displayed through a display of each of the first mobile terminal 100 and the second mobile terminal 400. The corresponding interactive message window corresponds to a virtual communication space VCR. The description method with reference to FIGS. 5 and 6 may be applied to a virtual communication space generated by the system 20B shown in FIG. 8 as it is.

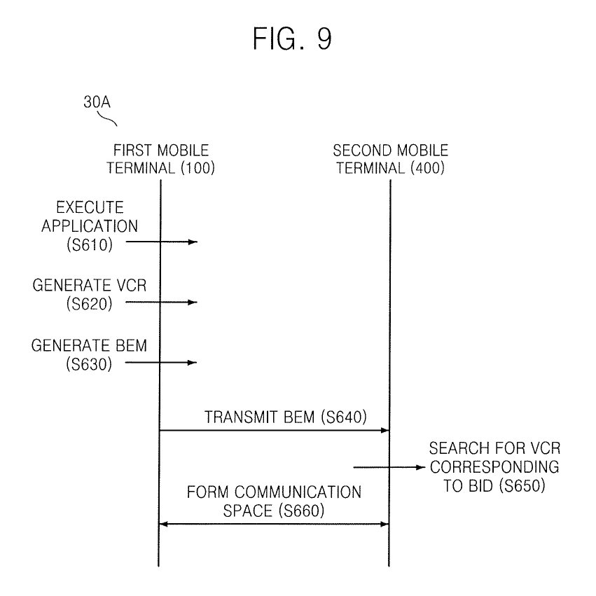

FIG. 9 shows a data flow of a system according to still another exemplary embodiment of the present inventive concepts. Referring to FIG. 9, a system 30A may include a first mobile terminal 100 and a second mobile terminal 400. In the system 30A shown in FIG. 9, unlike the systems 20A and 20B shown in FIGS. 7 and 8, a virtual communication space (VCR) may be generated within the first mobile terminal 100.

When the second mobile terminal 400 receives a beacon message BEM from the first mobile terminal 100, the first mobile terminal 100 may transmit an invitation to a chat room (for example, a virtual communication space VCR) to the second mobile terminal 400 through an application installed in the first mobile terminal 100. The second mobile terminal 400 may participate in the chat room based on the invitation. In other words, mobile terminals existing in the same space may use a communication service by participating in a chat room provided by an application installed in the first mobile terminal 100 or the first mobile terminal 100. At this time, the number of mobile terminals which can be invited to the chat room is not limited.

The first mobile terminal 100 which can serve as a beacon may execute an application installed in the first mobile terminal 100 (S610), and generate a virtual communication space (or virtual communication room (VCR)) in the first mobile terminal 100 using the application (S620).

The application installed in the first mobile terminal 100 may ask a user of the first mobile terminal 100 whether to generate a virtual communication space VCR and generate the virtual communication space VCR when approved by the user (S620). The user of the first mobile terminal 100 may access the virtual communication space VCR generated in the first mobile terminal 100.

The first mobile terminal 100 may generate a beacon message BEM including a beacon ID (BID) using an application installed in the first mobile terminal 100 (S630). According to an exemplary embodiment, the beacon ID (BID) may be the same as an ID (DID) of the first mobile terminal 100.

According to an exemplary embodiment, the beacon message BEM may further include digital contents. The digital contents may refer to a product that may be manufactured, distributed, and consumed in a digitized manner. For example, the digital contents D_CONTS may refer to text files, image files, video files, MP3 music files, or multimedia books.

For example, the user of the first mobile terminal 100 may generate a beacon message BEM including a beacon ID (BID), a text including a phrase to invite a user of the second mobile terminal 400 to a virtual communication space VCR, an image, and the like using an application installed in the first mobile terminal 100.

The second mobile terminal 400 may receive the beacon message BEM including a beacon ID (BID) from the first mobile terminal 100 (S640), and search for a virtual communication space VCR corresponding to the received beacon ID (BID) (S650).

For example, the search may refer to a case of using the beacon ID (BID) as a keyword when the second mobile terminal 400 activates a Bluetooth function and pairing using a keyword is performed. That is, the second mobile terminal 400 may search for a virtual communication space VCR generated in the first mobile terminal 100 using a beacon ID received from the first mobile terminal 100. The second mobile terminal 400 may access the searched virtual communication space VCR corresponding to the beacon ID (BID).

When both the first mobile terminal 100 and the second mobile terminal 400 access the virtual communication space VCR generated by the first mobile terminal 100, the first mobile terminal 100 may form the virtual communication space VCR so that the first mobile terminal 100 and the second mobile terminal 400 communicate messages with each other in real time (S660).

The messages may be displayed in real time through an interactive message window which is executed by an application installed in each of the first mobile terminal 100 and the second mobile terminal 400. That is, a corresponding interactive message window is displayed through a display of each of the first mobile terminal 100 and the second mobile terminal 400. The corresponding interactive message window corresponds to a virtual communication space VCR.

The description method with reference to FIGS. 5 and 6 may be applied to a virtual communication space generated by the system 30A shown in FIG. 9 as it is.

The present inventive concepts are not limited to the exemplary embodiments 5 described herein, and it would be apparent to those skilled in the art that various changes and modifications might be made without departing from the spirit and the scope of the present invention. Accordingly, it will be determined that the changed examples or modified examples are included in the appended claims of the present invention.

### INDUSTRIAL APPLICABILITY

The present inventive concepts are applicable to a method for providing a communication service using an operation server. Moreover, the present inventive concepts are applicable to an operation server.

1. A method for providing a communication service using a first mobile terminal communicating with a first NFC tag, a second mobile terminal communicating with a second NFC tag, and an operation server managing the first NFC tag and the second NFC tag, the method comprising:
receiving, by the operation server, a first tag ID of the first NFC tag through the first mobile terminal;
receiving, by the operation server, a second tag ID of the second NFC tag through the second mobile terminal and checking whether the first mobile terminal and the second mobile terminal are present in a same space using the first tag ID and the second tag ID; and
forming, by the operation server, a communication space so that the first mobile terminal and the second mobile terminal communicate messages with each other through the operation server in real time only when the first mobile terminal and the second mobile terminal are present in the same space.

2. The method of claim 1, further comprising displaying the messages through an interactive message window displayed on a display of each of the first mobile terminal and the second mobile terminal in real time by the operation server.

3. The method of claim 2,
wherein the interactive message window displayed on the first mobile terminal is automatically activated when an application installed in the first mobile terminal receives the first tag ID, and the interactive message window displayed on the second mobile terminal is automatically activated when an application installed in the second mobile terminal receives the second tag ID.

4. The method of claim 1,
wherein the first NFC tag and the second NFC tag are the same NFC tag installed in the same space.

5. A method for providing a communication service using a first mobile terminal communicating with a first beacon, a second mobile terminal communicating with a second beacon, and an operation server managing the first beacon and the second beacon, the method comprising:
receiving, by the operation server, a first beacon ID of the first beacon through the first mobile terminal;
receiving, by the operation server, a second beacon ID of the second beacon through the second mobile terminal and checking whether the first mobile terminal and the second mobile terminal are present in a same space using the first beacon ID and the second beacon ID; and
forming, by the operation server, a communication space so that the first mobile terminal and the second mobile terminal can communicate messages with each other through the operation server in real time only when the first mobile terminal and the second mobile terminal are present in the same space.

6. The method of claim 5, further comprising displaying the messages through an interactive message window displayed on a display of each of the first mobile terminal and the second mobile terminal in real time by the operation server.

7. The method of claim 5, further comprising:
asking, by an application installed in the first mobile terminal, a first user of the first mobile terminal whether to transmit the first beacon ID to the operation server and transmitting the first beacon ID to the operation server when approved by the first user; and
asking, by an application installed in the second mobile terminal, a second user of the second mobile terminal whether to transmit the second beacon ID to the operation server, and transmitting the second beacon ID to the operation server when approved by the second user.

8. A method for providing a communication service comprising:
executing, by a first mobile terminal serving as a beacon, an application installed in the first mobile terminal and requesting generation of a communication space to an operation server using the application;
receiving, by the first mobile terminal, a uniform resource locator (URL) of the communication space from the operation server and generating a beacon message including the URL; and
forming, by the operation server, the communication space only when a second mobile terminal receives the beacon message from the first mobile terminal so that the first mobile terminal and the second mobile terminal can communicate messages with each other through the operation server in real time.

9. The method of claim 8, further comprising displaying the messages through an interactive message window displayed on a display of each of the first mobile terminal and the second mobile terminal in real time by the operation server.

10. The method of claim 8, wherein the beacon message further comprises digital contents.

11. A method for providing a communication service comprising:
executing, a first mobile terminal serving as a beacon, an application installed in the first mobile terminal and requesting generation of a communication space to an operation server using the application;
receiving, by the first mobile terminal, a uniform resource locator (URL) of the communication space from the operation server and generating a beacon message including a beacon identification (ID);
receiving, a second mobile terminal, the beacon message from the first mobile terminal and transmitting the beacon ID to an ID search engine and receiving the URL of the communication space corresponding to the beacon ID from the ID search engine; and
forming, by the operation server, the communication space so that the first mobile terminal and the second mobile terminal communicate messages with each other through the operation server in real time.

12. The method of claim 11, further comprising displaying the beacon messages through an interactive message window displayed on a display of each of the first mobile terminal and the second mobile terminal in real time by the operation server.

13. A method for providing a communication service comprising:
executing, by a first mobile terminal serving as a beacon, an application installed in the first mobile terminal and generating a communication space in the first mobile terminal using the application;
generating, by the first mobile terminal, a beacon message including a beacon identification (ID);
receiving, by a second mobile terminal, the beacon message from the first mobile terminal and searching for a communication space corresponding to the beacon ID; and
forming, by the first mobile terminal, the communication space so that the first mobile terminal and the second mobile terminal communicate the beacon message with each other in real time.

14. The method of claim 13, further comprising displaying the beacon message through an interactive message window displayed on a display of each of the first mobile terminal and the second mobile terminal.

15. The method of claim 13,
wherein the beacon ID is the same as an ID of the first mobile terminal.

16. (canceled)
